(19) United States
(12) Patent Application Publication
(10) Pub. No.: US 2023/0294512 A1
(43) Pub. Date: Sep. 21, 2023

(54) DRIVE CONFIGURATION FOR VEHICLE

(71) Applicant: Arctic Cat Inc., Thief River Falls, MN (US)

(72) Inventors: David L. Vigen, Thief River Falls, MN (US); Dustin Keller, Lindstrom, MN (US)

(21) Appl. No.: 18/114,686

(22) Filed: Feb. 27, 2023

Related U.S. Application Data
(63) Continuation of application No. 16/224,521, filed on Dec. 18, 2018, now abandoned.
(60) Provisional application No. 62/607,173, filed on Dec. 18, 2017.

(51) Int. Cl. B60K 17/04; B60K 17/08; B60K 17/16; B60G 7/00; B60K 17/34; B60G 3/14

(52) U.S. Cl. CPC B60K 17/043; B60K 17/08; B60K 17/165; B60G 7/001; B60K 17/34; B60G 3/14; B60G 3/145; B60G 2300/07

(57) ABSTRACT

An off-road vehicle includes a frame, an engine, a rear ground engaging member, and a first rear trailing arm and a second rear trailing arm. Each of the trailing arms have at least one housing and wherein, within each housing is a drive belt, the drive belt drivingly coupled to the engine and a rear ground engaging member.

### CROSS-REFERENCE

This application is a continuation of U.S. application Ser. No. 16,224,521, filed on Dec. 19, 2018, which claims the benefit of priority to U.S. provisional application Ser. No. 62/607,173, titled “Drive Configuration for Vehicle”, filed Dec. 18, 2017, the contents of which are incorporated by reference herein. This application also incorporates by reference the subject matter of applications Ser. No. 15/244,793, 62/208,805, and Ser. No. 15/811,011, each titled, “Off-Road Vehicle”; the contents of each of which are herein incorporated by reference.

### BACKGROUND

Some off-road vehicles include a chassis, an engine, a transmission, a front drive system connected to front ground engaging members and a rear drive system connected to rear ground engaging members. Mechanical power developed by the engine is communicated to the ground engaging members through the front drive system and the rear drive system. The transmission, such as a transaxle, is located rear of the engine. The transaxle is connected to the wheels associated with the ground engaging members via a constant velocity (CV) joint that allows the wheels to “travel” relative to the vehicle frame while still providing motive force to the wheels.

### SUMMARY

According to some embodiments, an off-road vehicle includes a frame, an engine, a rear ground engaging member and first and second rear trailing arms. Each of the trailing arms have at least one housing and wherein, within each housing is a drive belt, the drive belt drivingly coupled to the engine and the rear ground engaging member.

According to some embodiments, an off-road vehicle includes a frame, an engine, a ground engaging member, a first trailing arm and a second trailing arm. Each of the trailing arms have at least one housing and wherein, within each housing is a drive belt, the drive belt drivingly coupled to the engine and a rear ground engaging member.

According to some embodiments, a trailing arm is drivingly coupled to a ground engaging member. The trailing arm includes, at least one housing member, a drive member coupled to receive mechanical power, a drive belt, and a driven member drivingly coupled to the drive member via the belt. The drive member, the belt and the driven member are housed within the at least one housing member.

### BRIEF DESCRIPTION OF THE DRAWINGS

FIG. 1 is an isometric view of an off-road vehicle having a trailing arm suspension according to some embodiments.

FIG. 2 is a side view of an off-road vehicle having a trailing arm suspension according to some embodiments.

FIG. 3 is a rear view of an off-road vehicle having a trailing arm suspension according to some embodiments.

FIG. 4 is a top view of an off-road vehicle having a trailing arm suspension according to some embodiments.

FIG. 5 is an isometric view of an off-road vehicle with the trailing arm of the rear suspension shown as partially exploded.

FIG. 6 is an exploded view of the trailing arm of the rear suspension according to some embodiments.

FIG. 7 is an exploded view of the rear suspension according to some embodiments.

FIG. 8 is an isometric view of the engine and transmission according to some embodiments.

FIG. 9 is a top view of an off-road vehicle having front and rear trailing arm suspensions according to some embodiments.

FIG. 10 is an isometric view of an off-road vehicle having front and rear trailing arm suspensions according to some embodiments.

FIG. 11 is an exploded view of the rear suspension according to some embodiments.

FIG. 12 is a side view of the off-road vehicle utilizing a trailing arm suspension in both the rear and front drive systems according to some embodiments.

FIG. 13 is a rear view of the off-road vehicle according to some embodiments.

FIG. 14 is an isometric view of a rear suspension and drive system according to some embodiments.

FIG. 15 is a top view of a rear suspension and drive system according to some embodiments.

FIG. 16 is a front view of a rear suspension and drive system according to some embodiments.

FIG. 17 is a side view of a rear suspension and drive system according to some embodiments.

FIG. 18 is a rear view of a rear suspension and drive system according to some embodiments.

In the drawings, which are not necessarily drawn to scale, like numerals may describe similar components in difference views. The drawings illustrate generally, by way of example, but not by way of limitation, various embodiments discussed in the present document.

### DETAILED DESCRIPTION

In some embodiments, this application discloses a suspension that includes a trailing arm that incorporates a drive belt to drivingly couple the engine to the ground engaging member. In some embodiments, the trailing arm pivots about a first end, wherein the pivot axis of the trailing arm is close in proximity to the connection of the half-axle with the trailing arm.

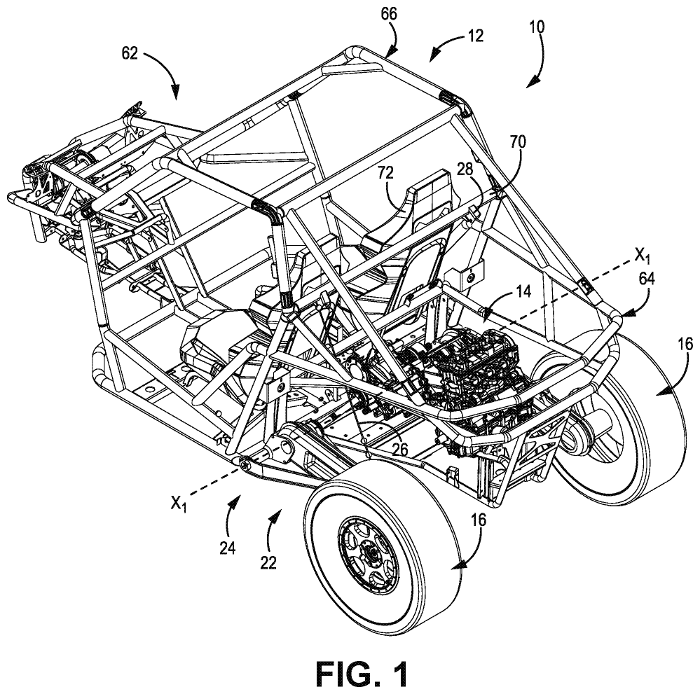

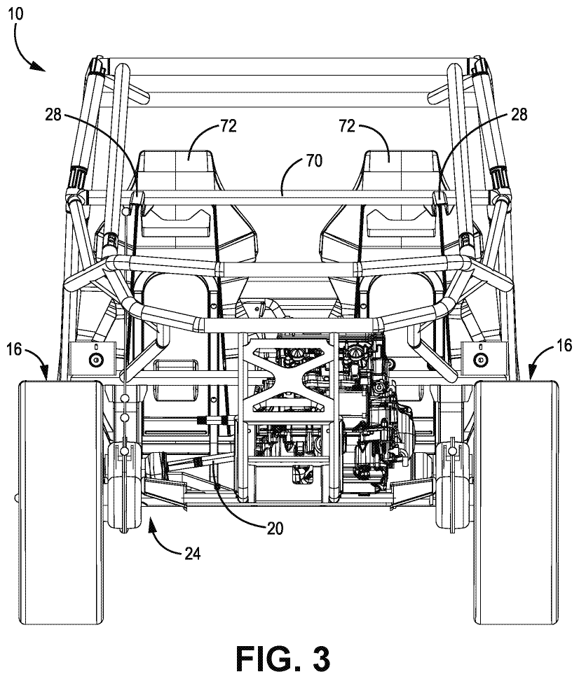

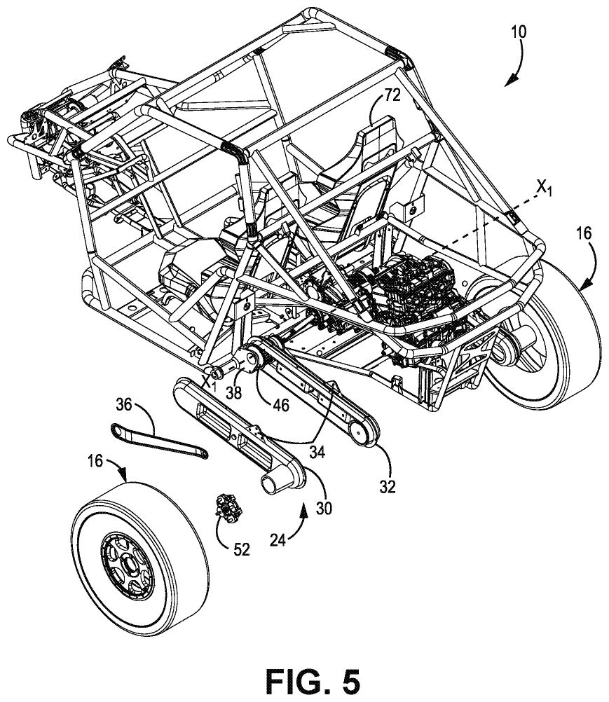

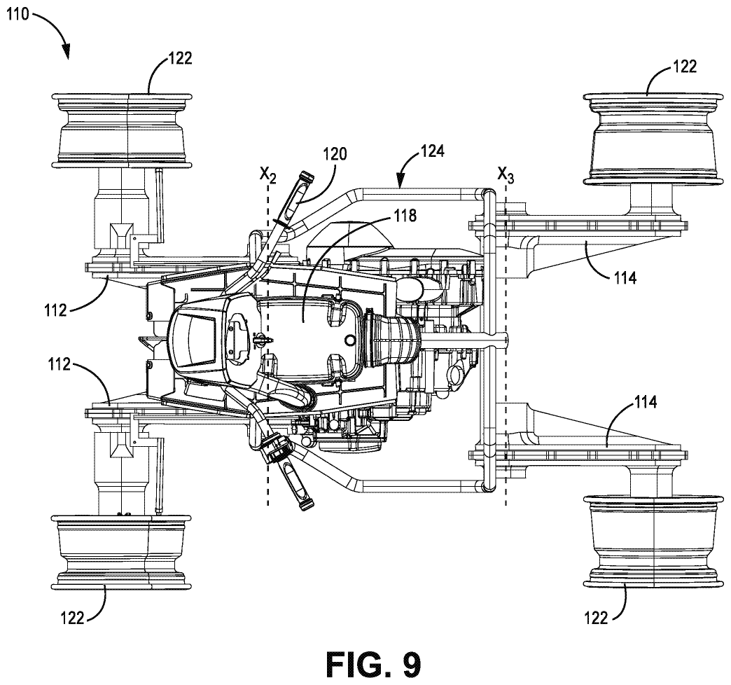

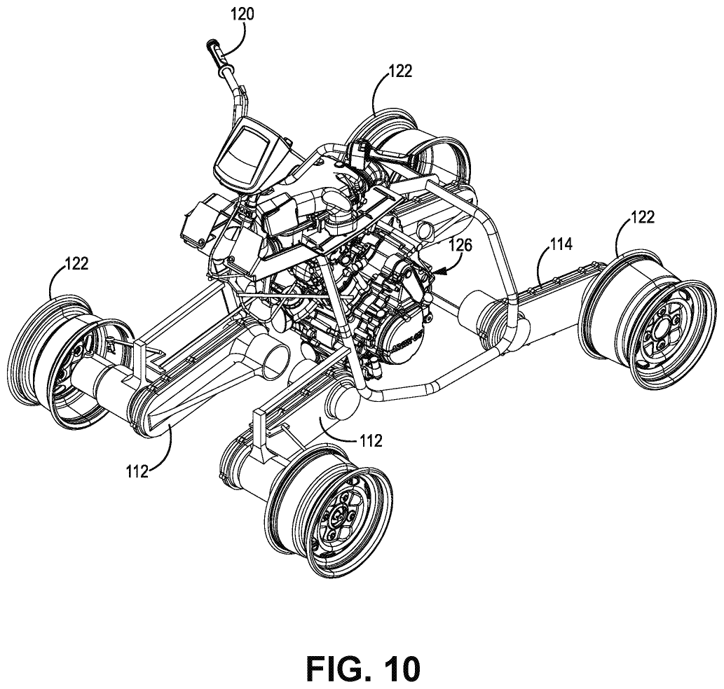

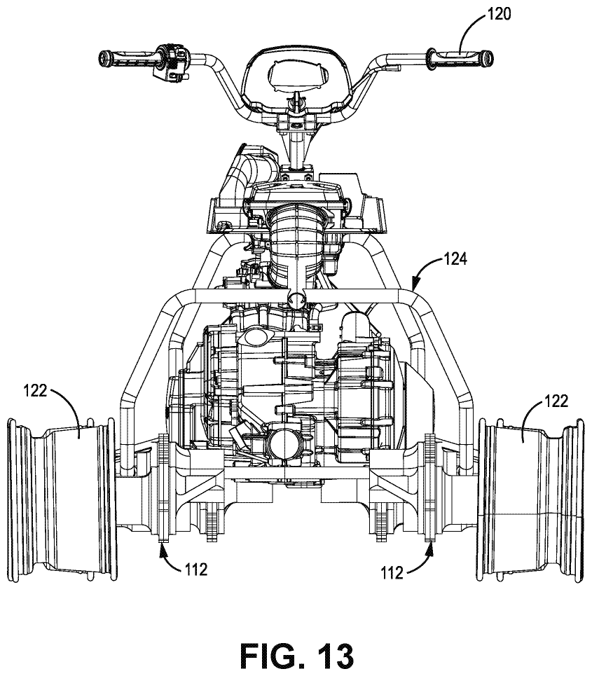

Referring now to FIGS. 1-8, an off-road vehicle 10 comprises a frame 12, an engine 14, and one or more ground engaging members 16. In some embodiments the frame 12 includes a front sub-frame 62, a rear sub-frame 64 and a roll-over protection system (ROPS) 66. The frame 12 includes a plurality of members connected to one another for example by bolts, fasteners, or weldments. The rear sub-frame 64 supports the engine 14 and a transmission 18 (e.g., transaxle). In some embodiments, the transmission 18 is coupled to the engine 14 via a continuously variable transmission. In some embodiments (shown in FIGS. 1, 2 and 4) the transmission 18 is located forward of the engine 14. In other embodiments (not shown), the transmission 18 may be located rearward of the engine 12. In some embodiments, one or more half-shafts 20 extend laterally from transmission 18 and include a constant velocity (CV) joint 74 that drivingly couples the transmission 18 to first and second trailing arms 24. As discussed in more detail with respect to FIGS. 5-7, the trailing arm 24 is utilized to drivingly couple the transmission 18 to the ground-engaging member 16. In some embodiments, the vehicle 10 includes a front suspension (not shown) and a rear suspension 22, including or more springs/shocks. In some embodiments, only the rear suspension 22 utilizes a trailing arm to drivingly couple the ground engaging members 16, while in other embodiments only the front suspension utilizes a trailing arm to drivingly couple the transmission 18 to the front ground engaging members 16; in some embodiments trailing arms are utilized to drivingly couple the transmission to both the front and rear ground engagine members (as shown in FIGS. 9-13). In some embodiments, a shock/spring 26 (e.g., coil-over) extends from the trailing arm 24 to a portion of the frame 12, such as first shock mount 28 located on cross-member 70.

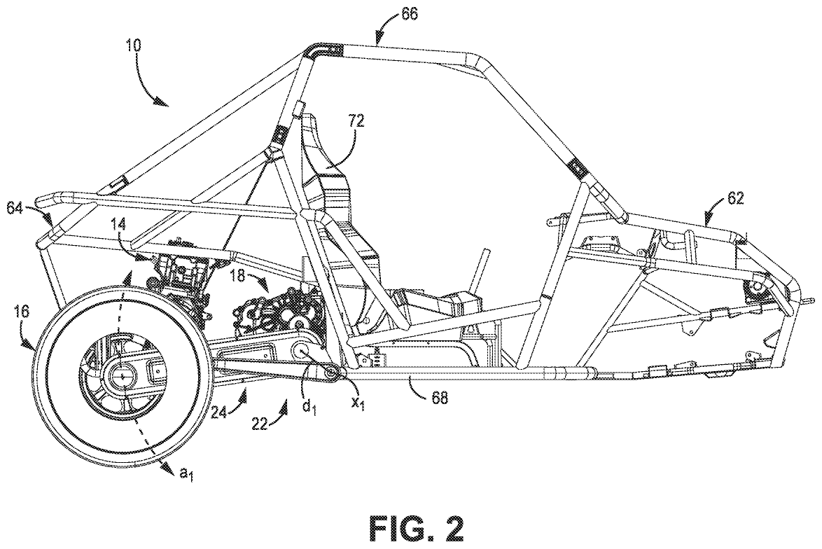

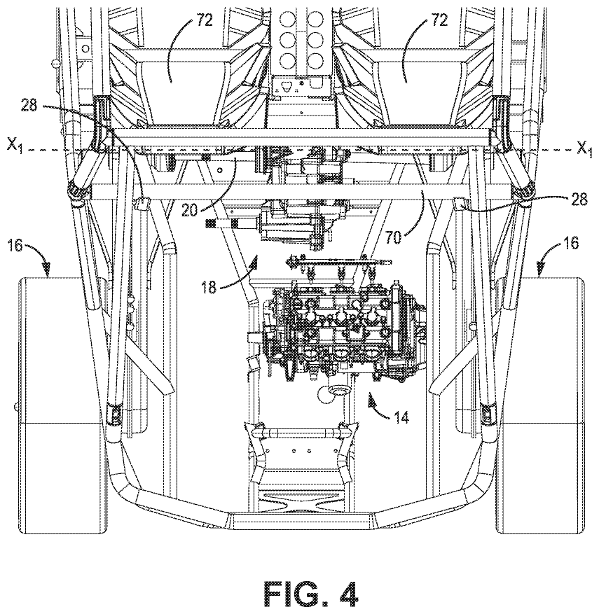

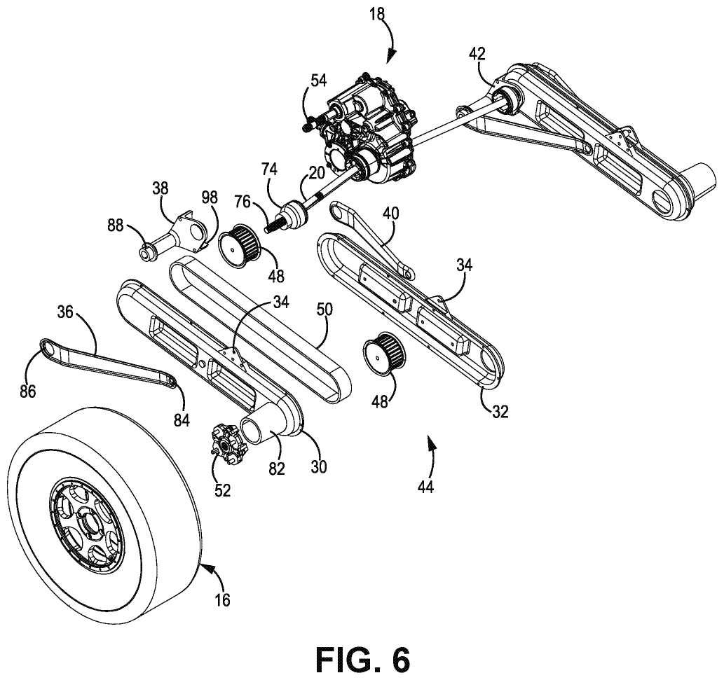

In some embodiments, trailing arm 24 includes a forward portion that is pivotally attached to the frame 12 of the vehicle and a rearward portion that is affixed to the ground engaging member 16. For example, FIGS. 1, 2, and 5 illustrate the pivot axis x₁ associated with the trailing arms 24. In some embodiments, trailing arm 24 is coupled to half-shaft 20 and CV joint 74 at a location that is close to or coaxial with pivot axis x₁. Trailing arm 24 includes a drive belt (or chain) 50 that drivingly couples the engine 14 to the rear ground engaging members 16, for example via transmission 18. The rear suspension 22, including the trailing arm 24, allows ground engaging member 16 to “travel” vertically in response to the terrain (e.g., bumps, holes) and/or changes in force applied (e.g., passengers getting in and out of the vehicle), wherein trailing arm 24 pivots about axis x₁ (shown in FIGS. 2 and 4). As a result, the rearward portion of trailing arm 24 as well as ground engaging member 16 travel vertically (and slightly horizontally) along an arc path a₁ shown in FIG. 2 (it should be noted, the arc path a₁ shown in FIG. 2 is approximated in order to illustrate the direction taken by ground engaging members during travel of the rear suspension). In some embodiments, a benefit of driving the transmission 18 and wheel engagine member 16 via trailing arm 24 is that the horizontal forces generated as a result of travel of the ground engaging member 16 reduce “tire scrub”, which is defined generally as the lateral travel of the ground engaging member 16 (i.e., perpendicular to the forward direction of the vehicle) that occurs when the tire travels vertically as the rear suspension 22 is compressed/uncompressed.. In some embodiments, a benefit of trailing arm 24 is the ability to increase the amount of travel available to rear suspension 22 and ground engaging members 16 when compared to typical arrangements while reducing/eliminating tire scrub. By way of example, the tire in suspension shown in U.S. Pat. No. 8,764,039, undergoues tire scrub (as defined herein) as the suspension compresses—the tire moves laterally, and follows an arc determined by the CV shaft and lateral links 150. In contrast, the trailing arm 24 disclosed herein need not move laterally as the suspension is compressed/extended and tire scrub can be reduced or eliminated. In some embodiments, another benefit of drivingly coupling engine 14 to ground engagine members 16 via trailing arm 24 is that movement and plunging of the CV joint 74 shown in FIG. 6 is reduced or eliminated by locating the pivot axis x₁ of trailing arm 24 in close proximity to the connection of rear half-shaft 20 to the trailing arm 24.

Referring specifically to FIGS. 5-7 the trailing arm assembly 24 is described in more detail. In some embodiments, trailing arm assembly 24 comprises one or more housings, such as a first housing 30 and a second housing 32, first trailing arm support 36, second trailing arm support 40, driving member 46, driven member 48, and belt/chain 50.

In some embodiments, one or both of the first and second housings 30, 32 include a second shock mount 34. As shown in FIG. 5, in some embodiments, a portion of the second shock mount 34 is coupled to the first housing 30 and a second portion of the second shock mount 34 is coupled to the second housing 32. The shock mount 34 can be formed integrally with the housing(s) 30, 32 or it can be attached thereto, for example by one or more fasteners. In some embodiments, the shock/spring 26 is connected between shock mount 34 and shock mount 28.

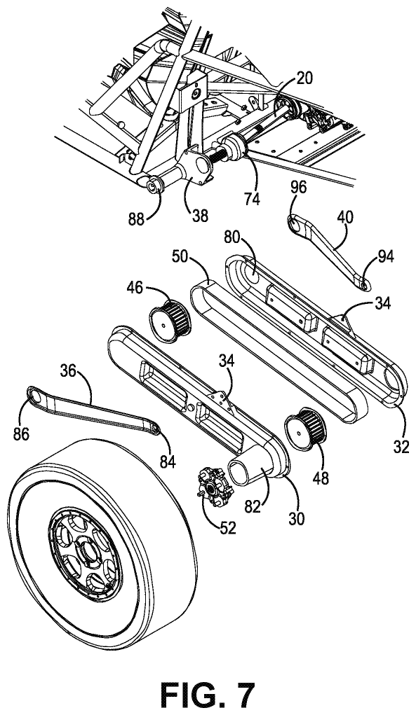

In some embodiments, the first housing 30 and the second housing 32 are fastened together, forming an enclosure that protects the driving member 46, the driven member 48 and belt/chain 50 from exterior elements. In some embodiments, first housing 30 and second housing 32 may form a seal when first housing 30 is brought into contact with second housing 32. In some embodiments, second housing 32 includes an aperture 80 (shown in FIG. 7) for receiving the splined portion 76 (shown in FIG. 6) of half-shaft 20, and the first housing 30 includes an aperture 82 for receiving a splined portion (not shown) for connecting the driven member 48 to the wheel hub 52, which in turn is connected to the ground engaging member 16. In some embodiments, transmission 18 is drivingly coupled to drive member 46 via rear half-shafts 20, CV joint 74, and spline 76. In turn, drive member 46 is drivingly coupled to driven member 48 via the belt 50. While a belt is utilized in the embodiment shown in FIGS. 5-8, in other embodiments a chain may be utilized to drivingly couple drive member 46 and driven member 48. In some embodiments, first and second trailing arm support hubs 38, 100 are fastened to first and second housing members 30, 32, respectively such that the assembly (including trailing arm support hub 38, first housing 30, second housing 32, first trailing arm support 36, and second trailing arm support 40) pivot together about the pivot axis x₁ as the suspension is compressed/uncompressed through its range of travel. In the embodiment shown in FIGS. 5-7, driven member 48 is located rearward of drive member 46 as trailing arm 24 is connected to rear ground engagine members 16. In other embodiments, trailing arm 24 could be utilized in combination with the front suspension in which driven member 48 would be located forward of drive member 46. In some embodiments, the transmission 18 further includes an output shaft 54 (FIG. 6) that can be used to provide power to a front differential to drive front ground engaging members (not shown).

In some embodiments, half-shaft 20 is coupled to drive member 46 (in the housing of trailing arm 24) at a location that is close to or or along the pivot axis of trailing arm 24 (illustrated by axis x₁). In some embodiments, the half-shaft 20 is coupled to the drive member 46 at a distance d₁ (FIG. 2) that is less than 12″ and, in some embodiments, less than 10″, 8″, or less than 5″. A benefit of coupling the half-shaft 20 to the trailing arm 24 at or near the pivot point of trailing arm 24 is that the travel of rear suspension 22 is allowed to be large without having a large plunge associated with half-shaft 20 or CV joint 74 (as discussed in U.S. Publication No. 2017/0248169) and further without excessive (or any) tire scrub, as discussed above.

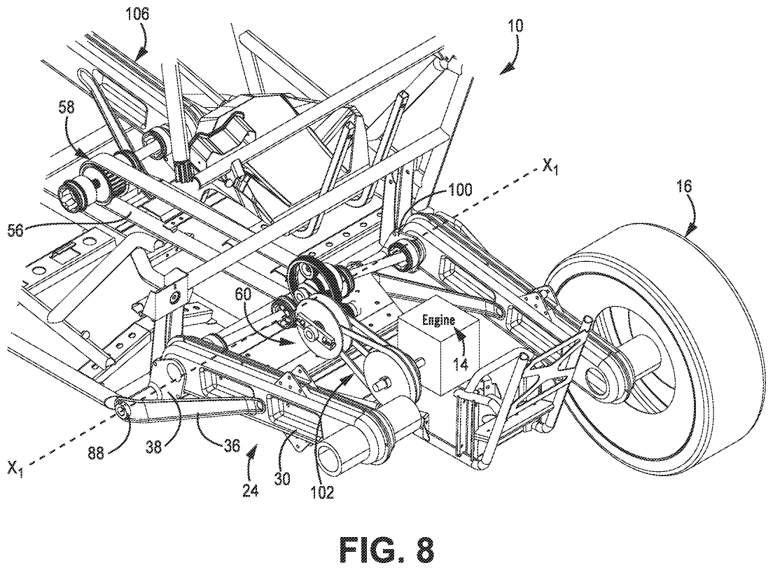

In some embodiments, first trailing arm support 36 and second trailing arm support 40 are coupled to the first and second housing members 30 and 32, respectively, to provide additional support. In some embodiments, first trailing arm support 36 includes a first end 84 and a second end 86. First trailing arm support is affixed to first housing 30 at a first end 84 and to arm support hub 38 on the second end 86. In some embodiment, first trailing arm support 36 is fastened to first housing 30 via one or more fasteners. Second trailing arm support 40 likewise includes a first end 94 and a second end 96, wherein the second trailing arm support 40 is affixed to the second housing 32 at a first end 94 and to a second arm support hub 100 (shown in FIG. 8, on the right-hand side of the vehicle) on a second end 96. In some embodiments, first trailing arm support 36 and second trailing arm support 40 are allowed to pivot, along with support hub 38, around an axis defined on second end 86 and second end 96, respectively. In some embodiments, this axis is along axis x₁. The first trailing arm support 36 and second trailing arm support 40 thereby pivot in response to travel of ground engaging member 16 along the arc path a₁ shown in FIG. 2, for example.

In some embodiments, first and second arm support hubs 38 and 100, respectively, are rigidly secured to the frame 12 and provide a ledge 98 (shown with respect to first arm support hub 38) that supports first housing member 30, wherein a ledge associated with second arm support hub 100 would provide support to second housing member 32. As discussed above, however, in some embodiments, the first and second arm support hubs 38 and 100 pivot with the first and second housing members 30, 32. In some embodiments, first housing member and second housing member 30, 32 are allowed to pivot within first and second arm support hubs 38 and 100 to accommodate travel of the ground engaging member 16.

Rear suspension 22 includes a trailing arm 24 having a first end and a second end, wherein the first end is drivingly coupled to the transmission 18 and the second end is drivingly coupled to the ground engaging member 16. Trailing arm 24 is allowed to pivot about an axis x₁ located on the first end, such that the ground engaging member 16 is allowed to travel. As discussed above, a benefit of drivingly coupling the ground engaging member 16 to the transmission 18 via the trailing arm 24 is that the arc path taken by the ground engaging member 16 reduces or eliminates tire scrub. In particular, the horizontal component of the arc path is in the direction of travel of the ground engaging member 16.

As discussed above, the same concept described with respect to the rear suspension shown in FIGS. 5-7 may be utilized with respect to the front suspension and drive system as well. For example, in the embodiment shown in FIG. 8, the transaxle 104 is coupled to engine 14 via continuously variable transmission (CVT) 102. Transaxle 104 provides power to the rear ground engaging members as described above with respect to FIGS. 5-7. In addition, in some embodiments, transaxle 104 is drivingly coupled to front drive 58 via main drive belt 56. In some embodiments, the front drive can be a front differential that is driven by a shaft or main drive belt 56, as desired. In some embodiments, the front drive 58 can be used in conjunction with front trailing arms 106 coupled to the front ground engaging members as previously described.

Referring now to FIGS. 9-13, an all-terrain vehicle (ATV) 110 is shown that utilizes front trailing arms 112 and rear trailing arms 114. In some embodiments, ATV 110 includes a straddle-seat 118, handlebars 120, wheels 122, frame 124, engine 126. In some embodiments, front wheels 122 are drivingly coupled to a front drive system (not shown) via front trailing arms 112. In some embodiments, rear wheels 122 are drivingly coupled to a rear drive system (not shown) via rear trailing arms 114. In some embodiments, both trailing arms are utilized for both front wheels 122 and back wheels 122.

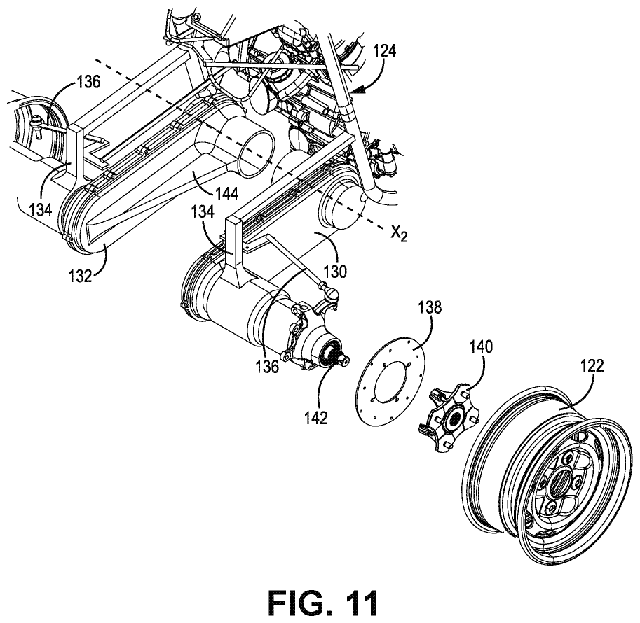

Referring in particular to FIG. 11, the front trailing arm 112 is shown connected to front wheel 122. In some embodiments, front trailing arm 112 includes first housing member 130 and second housing member 132, support members 134, and control arms 136. A front drive (not shown in this view) is drivingly coupled to front wheel 122 via a drive belt housed within front trailing arm 112. In some embodiments, front trailing arm 112 further includes a drive member and driven member drivingly coupled to one another via the belt, wherein the driven member is drivingly coupled to the wheel 122. First trailing arm 112 pivots about axis x₂, which causes wheel 122 to travel along an arc path shown by dashed line a₂. As described with respect to rear trailing arms 24, the front trailing arms 106 move along a path a₂, thereby reducing or eliminating tire scrub during travel of the front engaging member 16. In contrast, a typical front suspension accommodates travel of the front wheel via a constant velocity (CV) joint that results in horizontal force applied in a lateral direction. The front trailing arm 106 pivots about a lateral axis which results in a travel arc that has a horizontal component in the direction of travel of the vehicle (e.g., forward, backward).

Although not shown in FIGS. 9-13, in some embodiments, a front drive system is connected to front trailing arm 112 along axis x₂. In some embodiments, the front drive system includes a front differential coupled to the front trailing arm 112 via a CV joint and drive sprocket. A drive element (not shown) located within the first housing member 130 and second housing member 132 is coupled to the drive sprocket to receive rotational power from the front drive system. As discussed above with respect to FIGS. 5-8, the drive element is drivingly coupled via a belt or chain to a driven element, which in turn is coupled to shaft 142. As shown in FIG. 11, splined shaft 142 is coupled to wheel hub 140, which in turn is affixed to wheel 122.

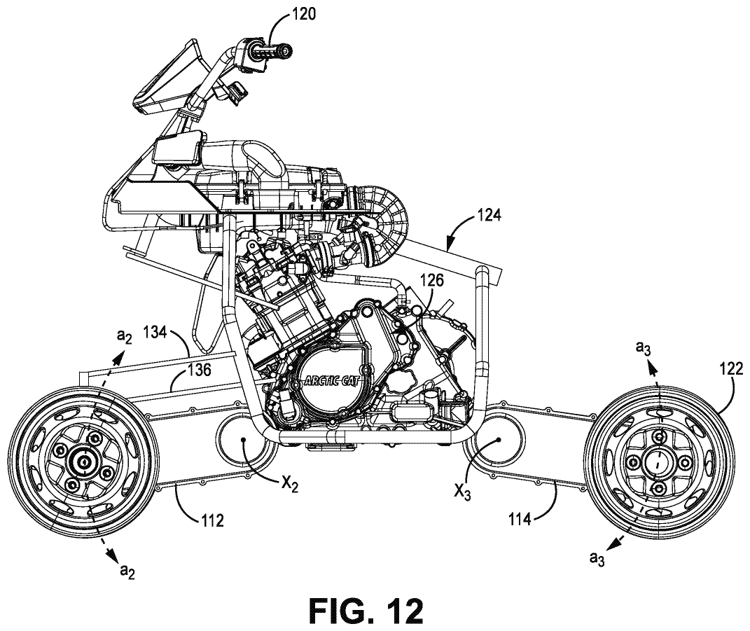

In the embodiment shown in FIGS. 11 and 12, control arms 136 are coupled through mechanical linkages to handlebars 120, allowing a driver to turn front wheels 122. Support 134 is coupled between front trailing arm 112 and frame 124. In some embodiments, support 134 includes a shock/spring system that allows vertical travel of wheels 122. In some embodiments, one or more trailing arm supports may also be affixed between first housing member 130, second housing member 132 and frame 124. In some embodiments, such as that shown in FIG. 11, the housing members include integrally formed supports such as support 144 integrated with second housing member 132.

As described with respect to off-vehicle 10 shown in FIGS. 1-8, drivingly coupling the front and/or rear wheels to the engine via front and/or rear trailing arms increases the front and/or rear suspension travel lengths as compared to known vehicle suspensions. In some embodiments, this is due, at least in part, to the half-shafts 20 providing power to respective ground engaging members 16 at or near the pivots of the trailing arms. In prior art designs, such as that shown in U.S. Pat. No. 8,746,719, the ground engaging members experience scrub as the suspension moves through its travel. Further, when looking forwardly at the vehicle from the rear of the vehicle, the knuckle shown in swings an arc as the suspension moves through its range of travel. And, the half-shaft associated with the suspension shown in experiences a minimal amount of plunge (e.g., less than 1″), due to the knuckle moving in an arc when viewed from the rear of the vehicle. This, however, can limit the suspension travel for a given-width vehicle. In contrast, however, the vehicle and suspension shown herein can have a greater degree of suspension travel, as the half-shafts 20 are located at or near the pivots of the trailing arms 24. In this way, the half-shafts 20 neither trace a large arc nor have a large degree of plunge.

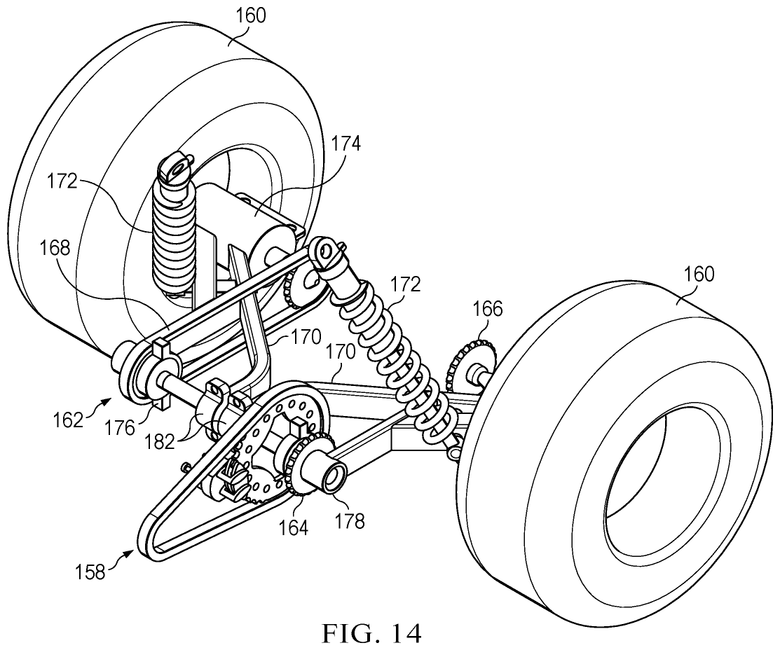

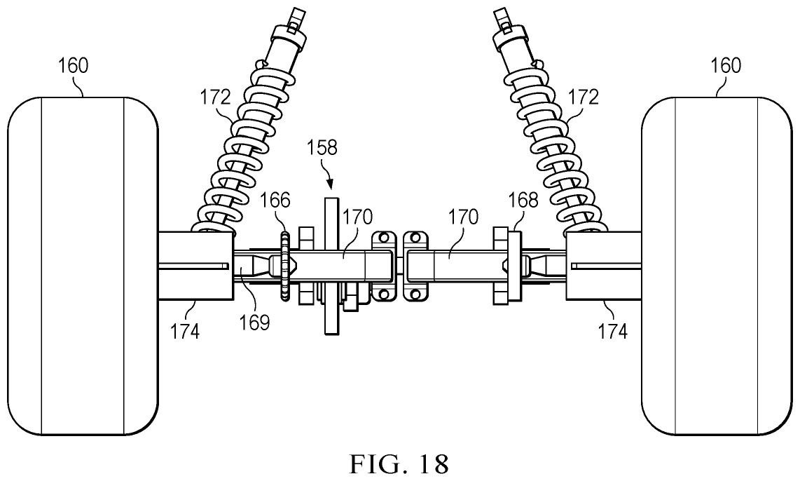

Referring now to FIGS. 14-18 a rear suspension and drive system is shown. The rear suspension and drive system includes primary drive chain/belt 158, ground engaging member 160, trailing arm 162, which includes drive member 164, driven member 166, belt/chain 168, and shaft 169, first support arm 170, spring/shock 172, wheel hub housing 174, shaft 176, trailing arm pivot 178, second support arm 180, second bearing/bushing 182, third bearing/bushing 184, brake caliper 186, and primary sprocket and brake disc 188. In this embodiments, the right side (far side in FIG. 14A) shows a belt 168. The left side (near side in FIG. 14A) shows the drive member 164 and driven member 166 with the belt 168 removed for clarity.

In some embodiments, primary drive chain/belt 158 is drivingly coupled to shaft 176, which in turn is connected to drive members 164. In some embodiments, the shaft 176 is supported by a bearings 182 and 184. In some embodiments, a bushing may be utilized in place of bearings for one or both of bearings 182 and 184. Drive member 164 is secured to shaft 176 and drivingly coupled to driven member 166 via belt 168. Driven member 166 is coupled to wheel hub housing 174 via shaft 169, which in turn is drivintly connected to ground engaging member 160. In some embodiments, one or more housing members enclose drive member 164, driven member 166 and belt 168.

In some embodiments, one or more trailing arm support members 170, 180 are coupled to the wheel hub housing 174 to provide additional support. In some embodiments, first trailing arm support member 170 is coupled on one end to bearings 182 and on an opposite end to wheel hub housing 174. In some embodiments, bearings 182 are affixed to the frame (not shown) of the off-road vehicle. In some embodiments, second trailing arm support member 180 is coupled on one end to wheel hub housing 174 and on an opposite end to trailing arm pivot 178. In some embodiments, second trailing arm support member 180 is a tube.

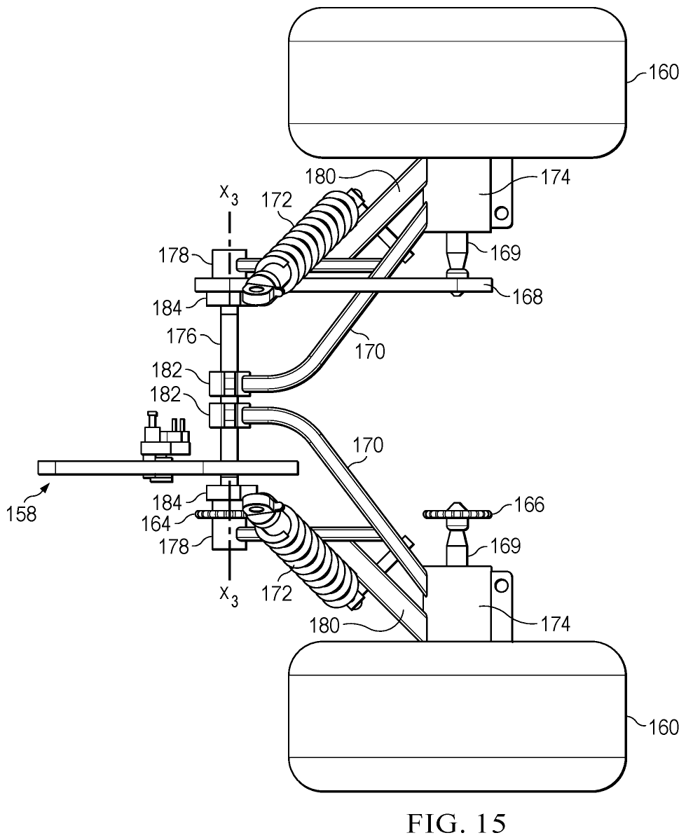

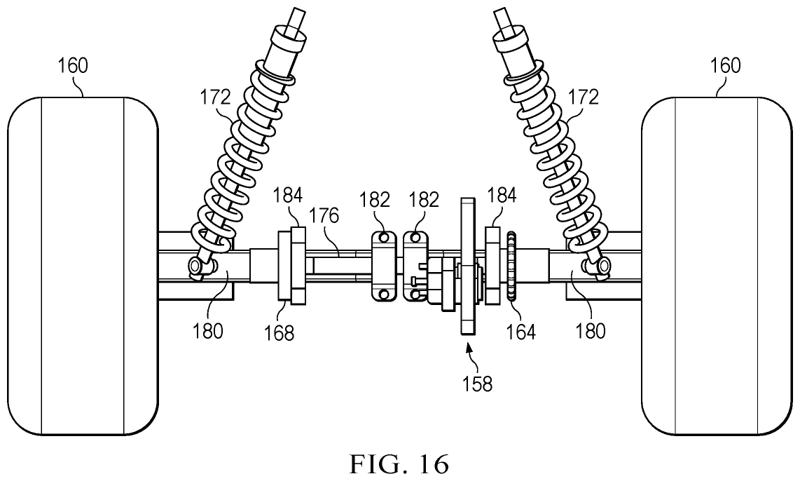

In some embodiments, spring/shock 172 is connected between the frame (not shown) and one or more of trailing arm support member 170 and/or 180. For example, in the embodiment shown in FIG. 16, the spring/shock 172 is affixed via fasteners to second trailing arm support member 180. In some embodiments, such as that shown in FIG. 15, spring/shock 172 is fastened to second trailing arm support member 180 and to first trailing arm support member 170.

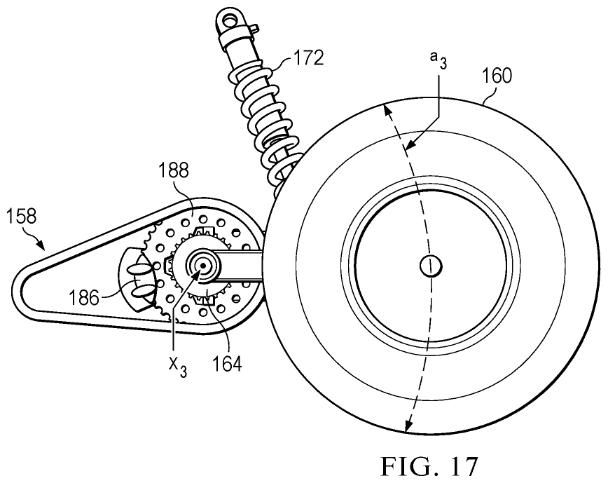

In some embodiments, the rear suspension including the trailing arm 162, allows ground engaging members 160 to “travel” vertically in response to the terrain (e.g., bumps, holes) and/or changes in force applied (e.g., passengers getting in and out of the vehicle), wherein trailing arm 162 pivots about axis x₃ (shown in FIGS. 15 and 17). As a result, the rearward portion of trailing arm 162 as well as ground engaging member 160 travel vertically (and slightly horizontally) along an arc path a₃ shown in FIG. 17 (it should be noted, the arc path a₃ shown in FIG. 17 is approximated in order to illustrate the direction taken by ground engaging members during travel of the rear suspension).

In this way, the disclosed invention provides a suspension that utilizes a trailing arm to couple the drive system to the ground engaging members.

What is claimed is:

1. An off-road vehicle comprising:
a frame;
an engine;
a rear ground engaging member; and
a first rear trailing arm and a second rear trailing arm, wherein each of the trailing arms have at least one housing and wherein, within each housing is a drive belt, the drive belt drivingly coupled to the engine and a rear ground engaging member.

2. The off-road vehicle of claim 1, further comprising a transaxle, wherein the transaxle is located forward of the engine and rearward of a seating area.

3. The off-road vehicle of claim 2, wherein the transaxle includes a first half-shaft and a second half-shaft extending laterally from the transaxle.

4. The off-road vehicle of claim 3, wherein the first half-shaft is coupled to the first rear trailing arm via a first constant velocity (CV) joint, and wherein the second half-shaft is coupled to the second rear trailing arm via a second CV joint.

5. The off-road vehicle of claim 3, wherein the first half-shaft is coupled to the first rear trailing member within 12″ of a pivot point of the first rear trailing member, and wherein the second half-shaft is coupled to the second rear trailing member within 12″ of a pivot point of the second rear trailing member.

6. The off-road vehicle of claim 1, wherein the first rear trailing arm includes a drive element drivingly coupled to the first half-shaft and a driven element drivingly coupled to the drive element via the drive belt.

7. The off-road vehicle of claim 1, further including a first trailing arm support member and a second trailing arm support member associated with the first trailing arm, wherein each trailing arm support is coupled to the at least one housing.

8. The off-road vehicle of claim 7, further including a first support hub and a second support hub affixed to the frame, wherein the first support hub and the second support hub support the first trailing arm.

9. The off-road vehicle of claim 8, wherein the first support hub includes a protrusion that is configured for connection to the first trailing arm support member and wherein the second support hub includes a protrusion that is configured for connection to the second trialing arm support member.

10. The off-road vehicle of claim 1, further including first front trailing arm and a second front trailing arm, wherein each of the front trailing arms have at least one housing and wherein, within each housing is a drive belt, the drive belt drivingly coupled to the engine and a front ground engaging member.

11. An off-road vehicle comprising:
a frame;
an engine;
a ground engaging member; and
a first trailing arm and a second trailing arm, wherein each of the trailing arms have at least one housing and wherein, within each housing is a drive belt, the drive belt drivingly coupled to the engine and a rear ground engaging member.

12. The off-road vehicle of claim 11, wherein the first trailing arm and the second trailing arm each include a drive member and a driven member, wherein the driven member is drivingly coupled to the drive member via the drive belt.

13. The off-road vehicle of claim 12, further including:
a driven shaft, wherein the drive members associated with the first trailing arm and the second trailing arm are coupled to the driven shaft.

14. The off-road vehicle of claim 13, wherein the first trailing arm and the second trailing arm pivot about a pivot axis.

15. The off-road vehicle of claim 14, wherein the pivot axis extends along an axis of the driven shaft.

16. The off-road vehicle of claim 15, further including:
at least a first trailing arm support member coupled on one end to the driven shaft and on an opposite end to housing associated with the ground engagine member.

17. The off-road vehicle of claim 16, wherein the first trailing arm support member is coupled to the driven shaft via a bearing assembly and/or bushing assembly.

18. A trailing arm drivingly coupled to a ground engaging member, the trailing arm comprising:
at least one housing member;
a drive member coupled to receive mechanical power;
a drive belt; and
a driven member drivingly coupled to the drive member via the belt, wherein the drive member, the belt and the driven member are housed within the at least one housing member.

19. The trailing arm of claim 18, wherein the trailing arm includes one or more trailing arm support members.

20. The trailing arm of claim 18, wherein the trailing arm pivots about an axis.
